(19) United States
(12) Patent Application Publication
(10) Pub. No.: US 2021/0063282 A1
(43) Pub. Date: Mar. 4, 2021

(54) RIM EXCHANGER, RIM HOLDING DEVICE, AND TIRE TEST SYSTEM

(71) Applicant: MITSUBISHI HEAVY INDUSTRIES MACHINERY SYSTEMS, LTD., Kobe-shi, Hyogo (JP)

(72) Inventors: Tatsuya UEDA, Hiroshima-shi, Hiroshima (JP); Jiro AGAWA, Hiroshima-shi, Hiroshima (JP); Makoto TACHIBANA, Hiroshima-shi, Hiroshima (JP); Morihiro IMAMURA, Hiroshima-shi, Hiroshima (JP)

(21) Appl. No.: 16/961,787

(22) PCT Filed: Feb. 2, 2018
(86) PCT No.: PCT/JP2018/003620

§ 371 Date: Jul. 13, 2020

(51) Int. Cl. G01M 17/02; B60C 25/00

(52) U.S. Cl. CPC G01M 17/021; B60C 25/002

(57) ABSTRACT

A rim exchanger includes a rim stocker. The rim stocker has an upper rim support portion that supports an upper rim, and a lower rim support portion that supports a lower rim. The upper rim support portion and the lower rim support portion have a pair of support arms separated from each other. A portion between an end of one support arm and an end of the other support arm forms an open end where a rim body enters a portion between the pair of support arms. An upper surface of one support arm forms a protrusion portion support surface which supports a protrusion portion of a rim from below.

### TECHNICAL FIELD

The present invention relates to a rim exchanger for exchanging a rim to fit into a bead portion of a tire with a rim holding machine which holds the rim, a rim holding device including the rim exchanger, and a tire test system including the rim holding device.

### BACKGROUND ART

In a case of manufacturing a rubber tire used for a vehicle, in order to ensure quality of the tire, various tests are performed on the tire in a state where the tire is artificially inflated (air-inflated) by using an inspection device. According to this type of the tire test system, the tire is transported to a tire test position by using a conveyor. Thereafter, the tire is held in such a way that a bead portion of the tire is the bead portion of the tire is interposed between an upper rim and a lower rim which are arranged at the tire test position. Then, in a state where the tire is held, various tests are performed on the tire.

In the tire test system, it is necessary to hold the tires having different sizes. Therefore, in many cases, the tire test system includes a rim exchanger for exchanging the upper rim and the lower rim with the rim holding machine, in addition to a rim holding machine for holding the upper rim and the lower rim.

A rim exchanger disclosed in PTL 1 includes an upper seat late on which the upper rim is placed, a lower seat plate on which the lower rim is placed, and a moving mechanism that moves the upper seat plate and the lower seat plate in a horizontal direction. A spindle hole penetrating in a vertical direction is formed in the upper seat plate. The upper rim has a rim body that fits into an upper bead portion of the tire, and a spindle portion that penetrates a center of the rim body. The upper rim is supported by the upper seat plate in a state where the spindle portion is inserted into the spindle hole and the rim body in contact with an upper surface of the upper seat plate. The moving mechanism causes the upper seat plate and the lower seat plate to move between a delivery position where the upper rim and the lower rim can be delivered to and from the rim holding machine and a retreat position away from the rim holding machine.

### CITATION LIST

### Patent Literature

[PTL 1] Japanese Patent No. 5313943

### SUMMARY OF INVENTION

### Technical Problem

According to the rim exchanger disclosed in PTL 1, when the upper rim is exchanged with the rim holding machine, the spindle portion of the upper rim needs to be inserted into and removed from a rim hole of the upper seat plate. Therefore, according to the rim exchanger disclosed in PTL 1, when the upper rim is exchanged with the rim holding machine, a time required for exchanging the rim is lengthened due to one of the following reasons 1), 2), and 3)

1) A distance for relatively moving the upper rim upward and downward with respect to the upper rim support is lengthened.

2) The number of steps of moving the upper rim upward and downward increases.

3) There are restrictions on timing for performing a step of moving the upper rim upward and downward and timing for performing a step of horizontally moving an upper and lower rim support section.

Therefore, the present invention aims to provide a rim, exchanger which can exchange a rim in a short time, a rim holding device including the rim exchanger, and a tire test system including the rim holding device.

### Solution to Problem

In order to achieve the above-described object, according to a first aspect of the invention, there is provided a rim exchanger for exchanging an upper rim and a lower rim each of which has a rim body to fit into a tire and a protrusion portion protruding from the rim body with a rim holding machine holding the upper rim and the lower rim which. The rim exchanger includes a rim stocker that supports the upper rim and the lower rim, and a stocker moving mechanism that moves the rim stocker between a delivery position where the upper rim and the lower rim can be delivered to and from the rim holding machine and a retreat position away from the rim holding machine. The rim stocker includes an upper and lower rim support section having an upper rim support portion that supports the upper rim, a lower rim support portion that supports the lower rim, and a connection portion that connects the upper rim support portion and the lower rim support portion to each other. Both the upper rim support portion and the lower rim support portion have a pair of support arms separated from each other in a horizontal direction, portion between a tip of one of the support arms and a tip of the other of the support arms forms an open end where the rim body enters a portion between the pair of support arms, and each upper surface of the pair of support arms forms a protrusion portion support surface which supports the protrusion portion from below.

In the rim exchanger, both the upper rim support portion and the lower rim support portion of the rim stocker have the open end. Accordingly, when the rim stocker is moved, the rim body of each rim can enter the portion between the two support arms without relatively moving the upper rim holding mechanism or the lower rim holding mechanism in the vertical direction with respect to the rim stocker. Therefore, owing to at least one of the following reasons 1), 2), and 3), a time required for exchanging the rim can be shortened.

1) A distance for relatively moving the upper rim upward and downward with respect to the upper rim support is shortened.

2) The number steps of moving the upper rim upward and downward decreases.

3) Restrictions are relaxed on timing for performing a step of moving the upper rim upward and downward and timing for performing a step of horizontally moving the upper and lower rim support section.

In order to achieve the above-described object, according to a second aspect of the invention, in the rim exchanger according to the first aspect, the lower rim support portion may be located relative to the upper rim support portion so that a center position of the upper rim when the upper rim support portion supports the upper rim and a center position of the lower rim when the lower rim support portion supports the lower rim coincide with each other, when viewed in a vertical direction.

In order to achieve the above-described object, according to a third aspect of the invention, in the rim exchanger according to the first aspect or the second aspect, the rim stocker may include a plurality of the upper and lower rim support sections, a stocker rotary shaft portion rotated around a stocker rotational axis extending in a vertical direction, and a stocker rotating mechanism that rotates the stocker rotary shaft portion. The plurality of upper and lower rim support sections may be fixed to the stocker rotary shaft portion so that the open end of each of the upper and lower rim support sections faces outward in a radial direction with respect to the stocker rotational axis.

The rim stocker of the rim exchanger has the plurality of upper and lower rim support sections. Therefore, the rim exchanger supports the upper rim and the lower rim which are to be exchanged with one upper and lower rim support section out of the plurality of upper and lower rim support sections. When the other remaining upper and lower rim support section is vacant, the rim stocker reciprocates once. In this manner, the upper rim and the lower rim can be exchanged between the rim holding machine and the rim exchanger.

In order to achieve the above-described object, according to a fourth aspect of the invention, in the rim exchanger according to any one of the first aspect to the third aspect, the stocker moving mechanism may hang and hold the rim stocker.

In the rim exchanger, a space below the rim stocker is not occupied by the stocker moving mechanism. Accordingly, the space below the rim stocker can be effectively used.

In order to achieve the above-described object, according to a fifth aspect of the invention, there is provided a rim holding device including the rim exchanger according to any one of the first aspect to the fourth aspect and the rim holding machine. The rim holding machine includes an upper rim holding mechanism that holds the upper rim to fit into an upper bead portion of the tire, a lower rim holding mechanism that holds the lower rim to fit into a lower bead portion of the tire, below the upper rim, a first rim moving mechanism that relatively moves the upper rim holding mechanism with respect to the lower rim holding mechanism in a vertical direction, a second rim moving mechanism that relatively moves a rim serving as a holding target of one rim holding mechanism in a vertical direction with respect to the one rim holding mechanism between the upper rim holding mechanism and the lower rim holding mechanism, and a conveyor that transports the tire on a transport passage extending in a horizontal direction.

In order to achieve the above-described object, according to a sixth aspect of the invention, the rim holding device, in the rim holding device according to the fifth aspect, the rim holding machine may include a conveyor lifting and lowering device that lifts and lowers the conveyor. The conveyor may include a belt conveyor that has a belt on which the tire is placed, and a lower rim support that supports the lower rim by coming into contact with the lower rim. The lower rim support may be located at a position different from that of the belt in the horizontal direction and below an upper surface of the belt, which is a position. The conveyor lifting and lowering device may configure the second rim moving mechanism.

In the rim holding device, the conveyor lifting and lowering device that relatively moves the lower rim in the vertical direction with respect to the lower rim holding mechanism together with the conveyor configures the second rim moving mechanism. In the rim holding device, when the lower rim is relatively moved with respect to the lower rim holding mechanism, the lower rim is supported by the lower rim support. Moreover, in the rim holding device, the lower rim support is located at the position below the upper surface of the belt, which is the position different from that of the belt in the horizontal direction. Therefore, in the rim holding device, when the lower rim is relatively moved with respect to the lower rim holding mechanism, the lower rim does not come into contact with the belt. Accordingly, the belt can be prevented from being damaged.

In order to achieve the above-described object, according to a seventh aspect of the invention, there is provided a tire test system including the rim holding device according to the fifth aspect or the sixth aspect, and a measuring instrument that performs various measurements on the tire mounted on the upper rim and the lower rim which are held by the rim holding machine.

### Advantageous Effects of Invention

According to an aspect of the present invention, a rim van be exchanged in a short time.

### BRIEF DESCRIPTION OF DRAWINGS

FIG. 1 is a plan view of a tire test system according to an embodiment of the present invention.

FIG. 2 is a sectional view taken along line II-II in FIG. 1.

FIG. 3 is a sectional view taken along line in FIG. 1.

FIG. 4 is a cutaway plan view of a main part of a center conveyor according to the embodiment of the present invention.

FIG. 5 is a sectional view taken along line V-V in FIG. 4.

FIG. 6 is a side view of a rim exchanger according to the embodiment of the present invention.

FIG. 7 is a perspective view of a rim stocker according to the embodiment of the present invention.

FIG. 8 is a side view of a rim holding machine and the rim exchanger after an exchange preparation step according to the embodiment of the present invention.

FIG. 9 is a side view of the rim holding machine and the rim exchanger after a receiving step according to the embodiment of the present invention.

FIG. 10 is a side view of the rim holding machine and the rim exchanger during a delivery step according to the embodiment of the present invention.

FIG. 11 is a side view of the rim holding machine and the rim exchanger after the delivery step according to the embodiment of the present invention.

FIG. 12 is a side view of the rim holding machine and the rim exchanger after a tire test preparation step according to the embodiment of the present invention.

### DESCRIPTION OF EMBODIMENTS

Hereinafter, an embodiment of a tire test system according to the present invention will be described with reference to the drawings.

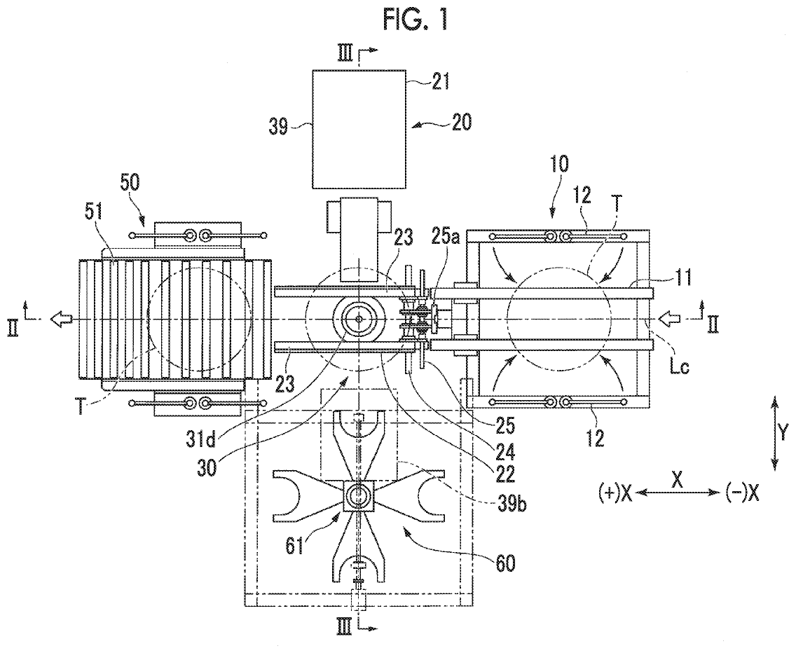

As illustrated in FIGS. 1 to 3, the tire test system according to the present embodiment includes a pre-treatment device 10 that performs pre-treatment on a tire T serving as a test target, an inspection device 20 that performs various tests on the tire T, a post-treatment device 50 that perform; post-treatment on the tire T after the tests, and a control device (not illustrated) that controls each operation of the devices 10, 20, and 50.

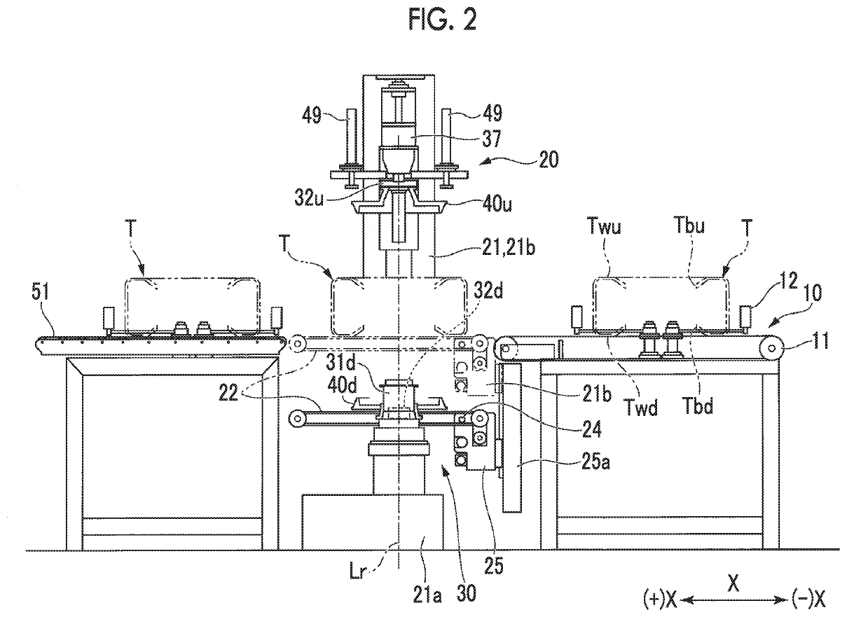

The pre-treatment device 10 includes an inlet conveyor 11, a centering mechanism 12, and a lubricant application mechanism (not illustrated). The inlet conveyor 11 transports the tire T in a predetermined direction. Hereinafter, the predetermined direction will be referred to as a transport direction X. In addition, one side in the transport direction X will be referred to as a downstream-side (+)X, and a side opposite to the downstream-side (+)X will be referred to as an upstream-side (−)X. The tire T is placed on the inlet conveyor 11 in a state where both side walls Twu and Twd (refer to FIG. 2) are oriented in a vertical direction. The inlet conveyor 11 transports the placed tire T from the upstream-side (−)X to the downstream-side (−)X.

The centering mechanism 12 locates a center of the tire T at a predetermined position of an inlet transport passage on the inlet conveyor 11. The predetermined position is located at the center in a passage width direction Y of an inlet transport passage. Therefore, the centering mechanism 12 centers the tire T. A lubricant application mechanism (not illustrated) applies a lubricant to an upper bead portion Tbu and a lower bead portion Tbd of the tire T which is subjected to centering.

The inspection device 20 includes a rim holding machine 30 a tire measuring instrument 39, a rim exchanger 60, and a frame 21 that supports these. According to the present embodiment, the rim holding machine 30 and the rim exchanger 60 configure a rim holding device. The rim holding machine 30 rotatably holds an upper rim 40u that fits into an upper bead portion Tbu of the tire T and a lower rim 40d that fits into a lower bead portion Tbd of the tire T. The rim holding machine 30 holds the tire T, when the tire T is mounted on the upper rim 40u and the lower rim 40d. Therefore, in some cases, the rim holding machine 30 may be called a tire holding machine. Therefore, hereinafter, in some cases, the rim holding machine 30 may be called a tire holding machine 30. The rim holding machine 30 includes a center conveyor 22. The center conveyor 22 is located on the downstream-side (+)X of the inlet conveyor 11, and transports the tire T in the same direction as the transport direction X of the inlet conveyor 11. Therefore, a passage width direction Y of a center transport passage of the center conveyor 22 is also the same direction as the passage width direction Y of an inlet transport passage. The tire measuring instrument 39 performs various measurements on the tire T held by the tire holding machine 30.

The post-treatment device 50 includes an outlet conveyor 51 and a marking mechanism (not illustrated). The outlet conveyor 51 is located on the downstream-side (+)X of the center conveyor 22, and transports the tire T in the same direction as the transport direction X of the inlet conveyor 11 and the center conveyor 22. Accordingly, the passage width direction Y of the outlet transport passage of the outlet conveyor 51 is the same as the passage width direction Y of the inlet transport passage and the center transport passage. A level in the vertical direction of the outlet transport passage is the same as a level in the vertical direction of the inlet transport passage.

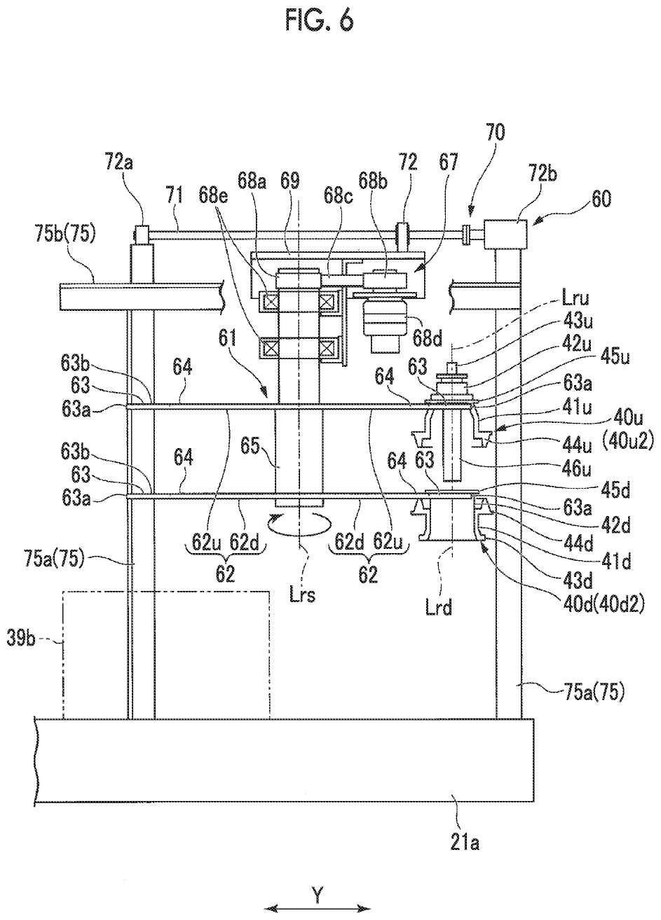

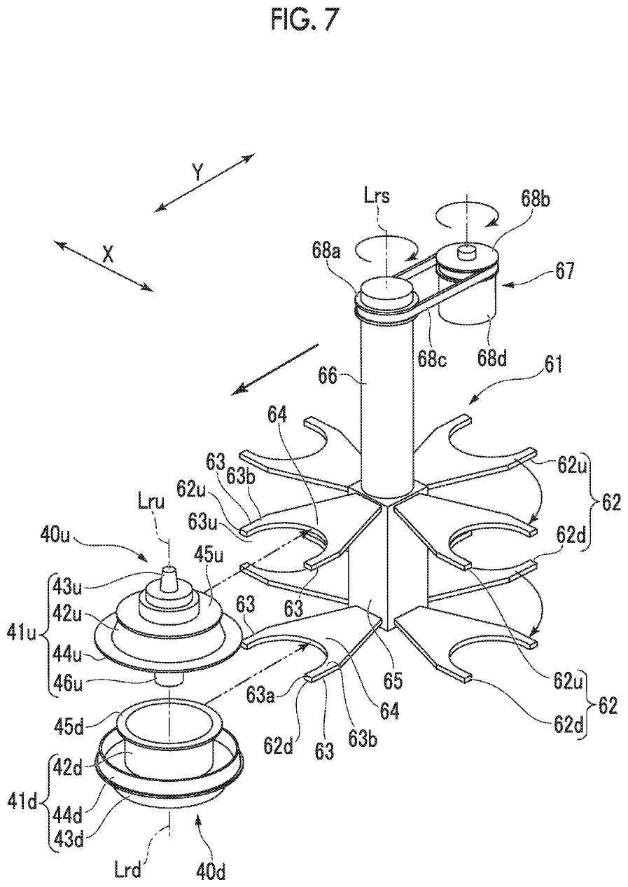

As illustrated in FIGS. 6 and 7, the upper rim 40u held by the rim holding machine 30 has an upper rim body 41u and an upper flange portion (protrusion portion) 45u. The upper rim body 41u has an upper rim cylinder portion 42u, an upper rim holding target portion 43u, an upper bead fitting portion 44u, and an upper spindle portion 46u. The upper rim cylinder portion 42u has a cylindrical shape formed around an upper rim axis Lru. Here, direction in which the upper rim axis Lru extends is set to an upper rim axis direction. One side in the upper rim axis direction is set to an upper side, and the other side is set to a lower side. The upper rim holding target portion 43u is a portion held by the rim holding machine 30. The upper rim holding target portion 43u is formed on the upper side of the upper rim cylinder portion 42u. The upper bead fitting portion 44u is a portion that fits into the upper bead portion Tbu of the tire T. The upper bead fitting portion 44u is formed on an outer peripheral side of the upper rim cylinder portion 42u. The upper spindle portion 46u has a columnar shape formed around the upper rim axis Lru. The upper spindle portion 46u is located on an inner peripheral side of the cylindrical upper rim cylinder portion 42u. A lower end of the upper spindle portion 46u protrudes downward from the upper rim cylinder portion 42u. The upper flange portion 45u protrudes outward in a radial direction from the upper rim cylinder portion 42u with respect to the upper rim axis Lru.

The lower rim 40d held by the rim holding machine 30 has a lower rim body 41d and a lower flange portion (protrusion portion) 45d. The lower rim body 4d has a lower rim cylinder port on 42d, a lower rim holding target portion 43d, and a lower bead fitting portion 44d. The lower rim cylinder portion 42d has a cylindrical shape formed around a lower rim axis Lrd. Here, a direction in which the lower rim axis Lrd extends is set to lower rim axis direction. One side in the lower rim axis direction is set to the upper side, and the other side is set to the lower side. The lower rim holding target portion 43d is a portion held by the rim holding machine 30. The lower rim holding target portion 43d is formed on the lower side of the lower rim cylinder portion 42d. The lower bead fitting portion 44d is a portion that fits into the lower bead portion Tbd of the tire T. The lower bead fitting portion 44d is formed on the outer peripheral side of the lower rim cylinder portion 42d. The lower flange portion 45d protrudes outward in the radial direction from the lower rim cylinder portion 42d with respect to the lower rim axis Lrd.

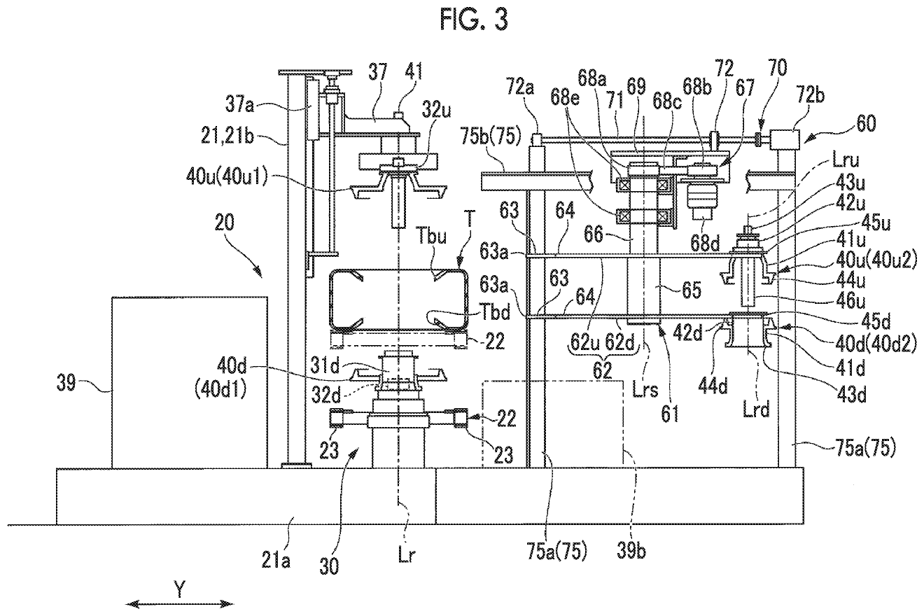

As illustrated in FIGS. 2 and 3, the rim holding machine 30 in the inspection device 20 includes the above-described center conveyor 22, and additionally includes an upper rim holding mechanism 32u, a tire stripper 49, a lower spindle 31d, a lower rim holding mechanism 32d, a rim elevator (first moving mechanism) 37, and the conveyor lifting and lowering device (second moving mechanism) 25.

The lower spindle 31d is a member having a columnar shape formed around a rotational axis Lr extending in the vertical direction. The lower spindle 31d is rotationally driven around the rotational axis Lr on a base 21a of the frame 21. The lower rim holding mechanism 32d holds the lower rim holding target portion 43d of the lower rim 40d. The lower rim 40d is held by the lower rim holding mechanism 32d. Accordingly, the lower rim axis Lrd and the rotational axis Lr coincide with each other. The upper rim holding mechanism 32u holds the upper rim holding target portion 43u of the upper rim 40u. The upper rim 40u is held by the upper rim holding mechanism 32u. Accordingly, the upper rim axis Lru and the rotational axis Lr coincide with each other. The tire stripper 49 is a mechanism that presses the upper side wall Twu of the tire T downward. The tire stripper 49 is configured to have an air cylinder, for example.

The rim elevator (first moving mechanism) 37 is supported by a main frame 21b of the frame 21 so as to be movable in the vertical direction via guide means 37a such as a linear guide. The above-described upper rim holding mechanism 32u and the tire stripper 49 are disposed in the rim elevator 37.

The rim elevator 37 is lifted and lowered in a state where the upper rim axis Lru of the upper rim 40u held by the upper rim holding mechanism 32u coincides with the rotational axis Lr of the lower spindle 31d. When the rim elevator 37 is lowered, a lower portion of the upper spindle portion 46u is inserted into the lower spindle 31d. The upper spindle portion 46u is coupled to the lower spindle 31d at a predetermined insertion position by a lock mechanism (not illustrated) disposed inside the lower spindle 31d. When the upper rim 40u having the upper spindle portion 46u is coupled to the lower spindle 31d by the lock mechanism, the upper rim 40u is integrally rotated in response to the rotation of the lower spindle 31d.

The above-described center conveyor 22 is supported by the main frame 21b via guide means 25a such as a linear guide so as to be movable in the vertical direction. The center conveyor 22 is lifted and lowered in the vertical direction between an upper limit position and a lower limit position by the conveyor lifting and lowering device 25 including a servo motor (not illustrated). The upper limit position of the center conveyor 22 is a position above a transport height position. As illustrated by imaginary lines in FIGS. 2 and 3, the transport height position is a position where a level of the upper surface of the center conveyor 22, in other words, a level of the center transport passage is the same as a level of the inlet transport passage and the outlet transport passage. As illustrated by solid lines in FIGS. 2 and 3, the lower limit position of the center conveyor 22 is a position where the level of the upper surface of the center conveyor 22 is below the lower rim 40d mounted on the lower spindle 31d. The lower limit position is a position below the above-described transport height position.

When the center transport passage of the center conveyor 22 is located at the transport height position, a virtual line extending through the rotational axis Lr of the lower spindle 31d and extending in the transport direction X on the center transport passage is a passage center line Lc (refer to FIG. 1). The passage center line Lc is the center in the passage width direction Y of the center transport passage. The centering mechanism 12 of the pre-treatment device 10 locates the center of the tire T on the passage center line Lc.

The center conveyor 22 has a pair of belts 23 away from each other with a predetermined distance in the passage width direction Y. That is, the center conveyor 22 is a belt conveyor. Out of the pair of belts 23, one belt 23 and the other belt 23 are arranged at symmetrical positions in the passage width direction Y, based on the passage center line Lc passing through the rotational axis Lr. An interval between the pair of belts 23 in the passage width direction Y can be adjusted by a known belt opening-closing mechanism 24. Therefore, when the center conveyor 22 is lifted and lowered, the lower spindle 31d and the lower rim 40d can pass between the pair of belts 23.

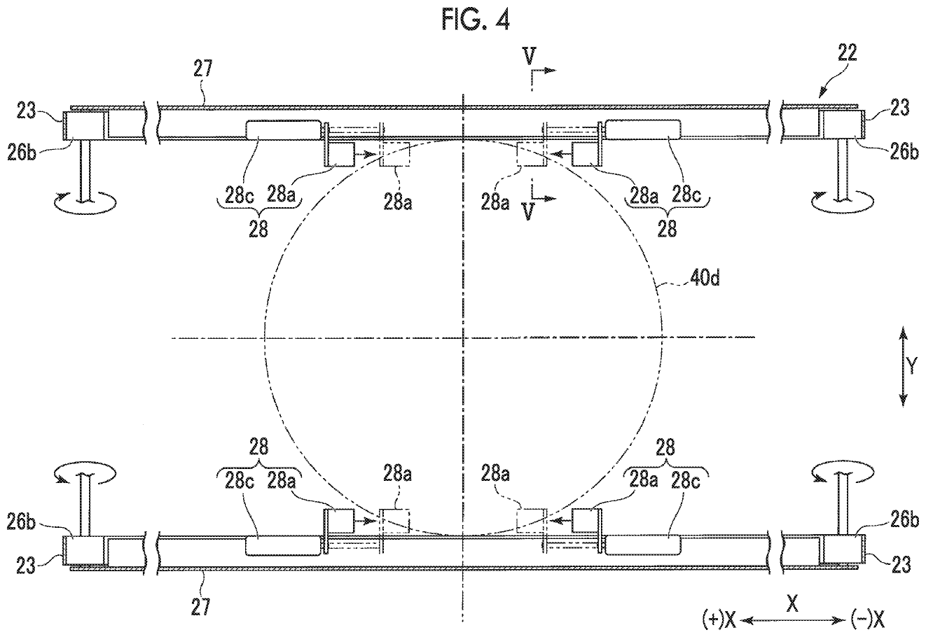

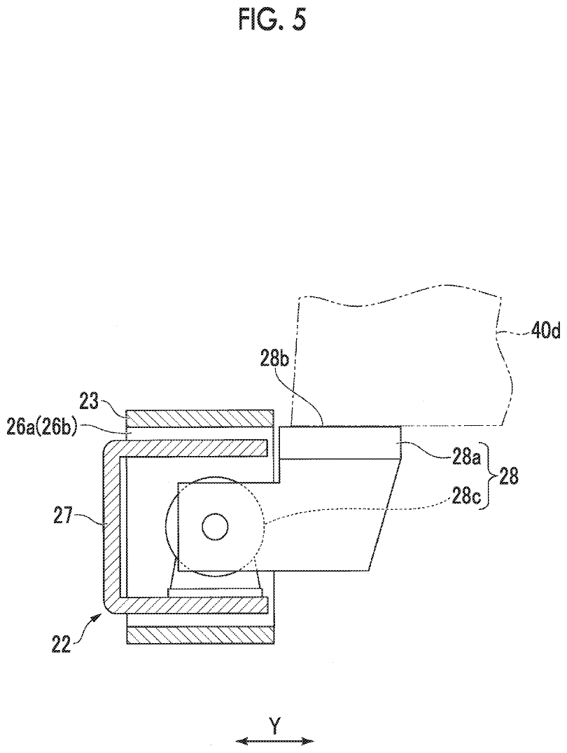

As illustrated in FIGS. 4 and 5, the center conveyor 22 further has an upstream-side pulley 26a and a downstream-side pulley 26b on which the belt 23 is hung, a conveyor frame 27 that rotatably supports the upstream-side pulley 26a and the downstream-side pulley 26b, and two lower rim support mechanisms 28. The upstream-side pulley 26a, the downstream-side pulley 26b, the conveyor frame 27, and the two lower rim support mechanisms 28 are present for each of the pair of belts 23. The conveyor frame 27 is a long member in the transport direction X. The upstream-side pulley 26a is rotatably supported by a portion on the upstream-side (−)X of the conveyor frame 27. The downstream-side pulley 26b is rotatably supported by a portion on the downstream-side (+)X of the conveyor frame 27. The belt 23 is hung on the upstream-side pulley 26a and the downstream-side pulley 26b. Both the two lower rim support mechanisms 28 have a lower rim support 28a and a support moving mechanism 28c that moves the lower rim support 28a in the transport direction X. The lower rim support 28a has a flat rim support surface 28b which faces upward. The support moving mechanism 28c that moves the lower rim support 28a is fixed to the conveyor frame 27. The support moving mechanism 28c is an air cylinder, for example.

Out of the two lower rim supports 28a, one lower rim support 28a is located on the upstream-side (−)X from the rotational axis Lr, and the other lower rim support 28a is located on the downstream-side (+)X from the rotational axis Lr. In addition, each of the lower rim supports 28a is located at a position different from that of the belt 23 supported by the conveyor frame 27 in the passage width direction Y. Specifically, out of the pair of belts 23, both the two lower rim supports 28a for one belt 23 are arranged on the other belt 23 side, based on one belt 23. The rim support surface 28b of the lower rim support 28a is located at a position below the upper surface of the belt 23, that is, the center transport passage. The lower rim support 28a located on the upstream-side (−)X from the rotational axis Lr is moved forward and rearward by the support moving mechanism 28c between a retreat position where the lower rim 40d cannot be supported and a support position where the lower rim 40d can be supported on the downstream-side (+)X from the retreat position. In FIG. 4, the lower rim support 28a located at the retreat position is indicated by a solid line, and the lower rim support 28a located at the support position is indicated by an imaginary line. The lower rim support 28a located on the downstream-side (+)X from the rotational axis Lr is moved forward and rearward by the support moving mechanism 28c between the retreat position where the lower rim 40dcannot be supported and the support position where the lower rim 40d can be supported on the upstream-side (−)X from the retreat position.

As illustrated in FIGS. 1, 6, and 7, the rim exchanger 60 includes a rim stocker 61 that supports the upper rim 40u and the lower rim 40d, a stocker moving mechanism 70 that moves the rim stocker 61 in the horizontal direction, and an exchanger frame 75.

The rim stocker 61 includes a plurality of upper and lower rim support sections 62, a stocker rotary shaft portion 66 rotating around a stocker rotational axis Lrs extending in the vertical direction, and a stocker rotating mechanism 67 that rotates the stocker rotary shaft portion 66.

The upper and lower rim support section 62 has an upper rim support portion 62u that supports the upper rim 40u, a lower rim support portion 62d that supports the lower rim 40d, and a connection portion 65 that connects the upper rim support portion 62u and the lower rim support portion 62d to each other. Both the upper rim support portion 62u and the lower rim support portion 62d have a pair of support arms 63 extending in the horizontal direction and an arm connecting portion 64. The pair of support arms is separated from each other in the horizontal direction perpendicular to an extending direction of the support arm 63. A distance dimension between the pair of support arms 63 is slightly larger than an outer diameter dimension of the cylinder portion 42 of the upper rim 40u and the lower rim 40d. The arm connecting portion 64 connects a base end of one support arm 63 and a base end of the other support arm 63, out of the pair of support arms 63. A portion between the tip of one support arm 63 and the tip of the other support arm 63 forms an open end 63a where the cylinder portion 42 of the upper rim 40u and the lower rim 40d enters a portion between the pair of support arms 63. The upper surface of the pair of support arms 63 in the upper rim support portion 62u forms a flange support surface (protrusion portion support surface) 63b that supports the upper flange portion 45u of the upper rim 40u from below. The upper surface of the pair of support arms 63 in the lower rim support portion 62d forms a flange support surface (protrusion portion support surface) 63b that supports the lower flange portion 45d of the lower rim 40d from below.

The connection portion 65 connects the arm connecting portion 64 of the upper rim support, portion 62u and the arm connecting portion 64 of the lower rim support portion 62d to each other so that the open end 63a of the lower rim support portion 62d is present on the lower side of the open end 63a of the upper rim support portion 62u, and so that the arm connecting portion 64 of the lower rim support portion 62d is present on the lower side of the arm connecting portion 64 of the upper rim support portion 62u. A center position of the lower rim 40d supported by the lower rim support portion 62d coincides with a center position of the upper rim 40u supported by the upper rim support portion 62u, when viewed in the vertical direction. In other words, the lower rim axis Lrd of the lower rim 40d supported by the lower rim support portion 62d is located on an extension line of the upper rim axis Lru of the upper rim 40u supported by the upper support portion 62u.

The plurality of upper and lower rim support sections 62 are fixed to the stocker rotary shaft portion 66 so that the open end 63a of the respective upper and lower rim support sections 62 faces outward in the radial direction with respect to the stocker rotational axis Lrs. A portion of the stocker rotary shaft portion 66 configures the connection portion 65 of the respective upper and lower rim support sections 62. The stocker rotational axis Lrs is parallel to the rotational axis Lr of the rim holding machine 30. A position of the stocker rotational axis Lrs is shifted from the rotational axis Lr in the passage width direction Y.

The stocker rotating mechanism 67 has a driven pulley 68a, a driving pulley 68b, a belt 68c laid between the two pulleys 68a and 68b, a motor 68d that rotates the driving pulley 68b, a bearing 68e, and a base 69. The driven pulley 68a is attached to an upper end of the stocker rotary shaft portion 66. The bearing 68e supports the stocker rotary shaft portion 66 to be rotatable around the rotational axis Lrs. The hearing 68e and the motor 68d are fixed to the base 69. The above-described configuration is an example of the configuration of the stocker rotating mechanism 67, and other configurations may be adopted. For example, the stocker rotating mechanism 67 may be configured to include a motor directly connected to the stocker rotary shaft portion 66.

The exchanger frame 75 has a plurality of columns 75a erected on the base 21a of the frame 21, and a plurality of cross beams 75b for connecting the upper portions of the plurality of columns 75a to each other.

The stocker moving mechanism 70 has a screw shaft 71 extending in the passage width direction Y, a nut member 72 screwed into the screw shaft 71, a bearing 72a for supporting the screw shaft 71 to be rotatable around a central axis thereof, and a motor 72b for rotating the screw shaft 71 around a rotational axis thereof.

The screw shaft 71 is located above the rim stocker 61 and the exchanger frame 75. An output shaft of the motor 72b is connected to one end of the screw shaft 71. In addition, the other end of the screw shaft 71 is supported by the bearing 72a. The motor 72b and the bearing 72a are fixed to an upper portion of any one of the exchanger frames 75. The nut member 72 is fixed to the base 69 of the stocker rotating mechanism 67.

According to the above-described configurations, when the motor 72b is driven and the screw shaft 71 is rotated around a central axis thereof, the nut member 72 and the rim stocker 61 connected to the nut member 72 move in the passage width direction Y. The rim stocker 61 moves in the passage width direction Y between a delivery position and a retreat position. The delivery position is a position where the upper rim 40u and the lower rim 40d can be delivered to and from the rim holding machine 30 by any one upper and lower rim support section 62 out of the plurality of upper and lower rim support sections 62. At the delivery position, the upper rim axis Lru of the upper rim 40u supported by one upper and lower rim support section 62 and the lower rim axis Lrd of the lower rim 40d are located on the rotational axis Lr of the rim holding machine 30. Accordingly, at the delivery position, a portion of the rim stocker 61 overlaps the rim holding machine 30, when viewed in the vertical direction. The retreat position is a position where one upper and lower rim support section 62 is away from the rim holding machine 30 to a side on which the arm connecting portion 64 is present with respect to the open end 63a of the one upper and lower rim support section 62 when being located at the delivery position. In addition, the retreat position is a position where the plurality of upper and lower rim support sections 62 do not come into contact with the tire T transported in the transport direction X on the rim holding machine 30 and the center conveyor 22 even if the plurality of upper and lower rim support sections 62 are rotated around the stocker rotational axis Lrs.

Although no illustrated, the stocker moving mechanism 70 according to the present embodiment has a rail extending in the passage width direction Y and a guide which is slidable on the rail. The rail is fixed to the exchanger frame 75. The guide is connected to the base 69 of the rim stocker 61, for example. The rails and guides guide a movement direction of the rim stocker 61, and have a role in which the rim stocker 61 is supported by the exchanger frame 75 so that the rim stocker 61 is movable with respect to the exchanger frame 75. Both the rails and guides are located above the plurality of upper and lower rim support sections 62. That is, the stocker moving mechanism 70 is located above the plurality of upper and lower rim support sections 62, hangs and holds the rim stocker 61, and moves the rim stocker 61 in the passage width direction Y.

Next, an operation of the above-described tire test system will be described. When the tire T is placed on the inlet conveyor 11, the centering mechanism 12 of the pre-treatment device 10 is operated, and the center of the tire T is located in the center of the inlet transport passage, in other words, on the passage center line Lc. After the centering mechanism 12 is operated, a lubricant application mechanism of the pre-treatment device 10 applies a lubricant to the upper bead portion Tbu and lower bead portion Tbd of the tire T.

When the lubricant is completely applied to the tire T, the inlet conveyor 11 and the center conveyor 22 start to be driven, and the tire T is transported to the downstream-side (+)X. When the tire T is transported into a test region, the center conveyor 22 stops. The test region is a region having a columnar shape formed around the rotational axis Lr and having almost the same outer diameter as the outer diameter of the tire T.

When the center conveyor 22 stops, the conveyor lifting and lowering device 25 is driven, and the center conveyor 22 and the tire T placed thereon are lowered. The upper surface of the center conveyor 22 is lowered to a position below the lower rim 40d. In the lowering process, the lower bead portion Tbd of the tire T fits into the lower rim 40d mounted on the lower spindle 31d, and the tire T is brought into a state where the tire T is supported by the center conveyor 22 and the lower rim 40d from below.

Next, the upper rim 40u held by the upper rim holding mechanism 32u is lowered by driving rim elevator 37. Since the upper rim 40u is lowered, the upper bead portion Tbu of the tire T fits the upper rim 40u. As a result, the tire T is interposed between the upper rim 40u and the lower rim 40d. In addition, the lower portion of the upper spindle portion 46u enters the lower spindle 31d. The upper spindle portion 46u is coupled to the lower spindle 31d by a lock mechanism (not illustrated) disposed in the lower spindle 31d.

Thereafter, air is supplied into the tire T from the outside through the upper spindle portion 46u or the lower spindle 31d. When the air is supplied into the tire T, the lower spindle 31d is rotated. In response to the rotation of the lower spindle 31d, the lower rim 40dmounted on the lower spindle 31d and the upper rim 40u coupled to the lower spindle 31d are rotated integrally with the lower spindle 31d. As a result, the tire T interposed between the upper rim 40u and the lower rim 40d is also rotated. While the tire T is rotated, various measurements are performed on the tire T.

When various measurements are completed as described above, the air is extracted from the tire T. Furthermore, a coupled state between the upper rim 40u and the lower spindle 31d is released by a locking mechanism. The upper rim 40u released from the coupled state with the lower spindle 31d is lifted by driving the rim elevator 37. When the upper rim 40u moves rearward and upward, the conveyor lifting and lowering device 25 is driven, and the center conveyor 22 is lifted to the transport height position. The tire T is lifted in response to the lifted center conveyor 22. On the other hand, the lower rim 40d into which the lower bead portion Tbd of the tire T fits is not lifted. Therefore, the lower bead portion Tbd of the tire T is separated from the lower rim 40d in the lifting process of the tire T. Thereafter, the plurality of tire strippers 49 disposed in the rim elevator 37 are driven, and the tire T is relatively pressed downward with respect to the upper rim 40u. As a result, the upper bead portion Tbu of the tire T is separated from the upper rim 40u. The upper bead portion Tbu may be pulled out from the upper rim 40u by driving the tire stripper 49, when the upper spindle 31u is lifted before the center conveyor 22 is lifted. According to the above-described operation, the tire T is pulled out from the upper rim 40u and the lower rim 40d.

When the tire T is pulled out from the upper rim 40u and the lower rim 40d, the center conveyor 22 is driven, and the tire T on the center conveyor 22 is transported to the downstream-side (−)X. As described above, the transport height position of the center conveyor 22 is the position where the level of the center transport passage is the same as the level of the inlet transport passage and the outlet transport passage. Therefore, the tire T on the center conveyor 22 is transferred from the center conveyor 22 to the outlet conveyor 51. On the outlet conveyor 51, the tire T is marked with various information items such as measurement results by a marking mechanism (not illustrated).

The tire test system also performs various tests relating to the tires having different sizes. Therefore, the tire test system includes a belt opening-closing mechanism 24 that adjusts an interval between the pair of belts 23 configuring the center conveyor 22 in the passage width direction Y. Furthermore, the tire test system includes a rim exchanger 60 for exchanging the upper rim 40u and the lower rim 40d which fit into the tire T.

Here, as illustrated in the upper rim 40u held by the rim holding machine 30 is set as a first upper rim 40u1, and the lower rim 40d held by the rim holding machine 30 is set as a first lower rim 40d1. In addition, the upper rim 40u to be exchanged with the first upper rim 40u1 is set as a second upper rim 40u2 and the lower rim 40d to be exchanged with the first lower rim 40d1 is set as the second lower rim 40d2.

When the upper rim 40u and the lower rim 40d are exchanged, as illustrated in FIG. 3, the tire T is not mounted on the first upper rim 40u1 and the first lower rim 40d1 which are held in the rim holding machine 30. In addition, the center conveyor 22 is located at the lower limit position. In addition, the second upper rim 40u2 and the second lower rim 40d2 are supported by one upper and lower rim support section 62 out of the plurality of upper and lower rim support sections 62. Out of the plurality of upper and lower rim support sections 62, the other upper and lower rim support sections 62 does not support the upper rim 40u and the lower rim 40d. The open end 63a of the other upper and lower rim support section 62 faces the rim holding machine 30 side, more precisely, the rotational axis Lr side of the rim holding machine 30. In addition, the rim stocker 61 which supports the second upper rim 40u2 and the second lower rim 40d2 is located at the retreat position.

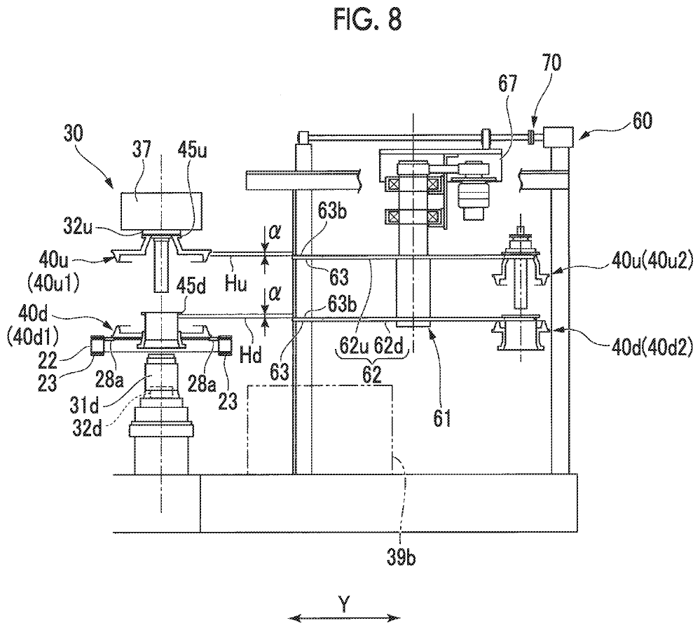

When the upper rim 40u and the lower rim 40d are exchanged, an exchange preparation step is first performed. In the exchange preparation step, as illustrated in FIG. 4, all of the support moving mechanism 28c of the center conveyor 22 are first driven. As illustrated by an imaginary line in FIG. 4, all of the lower rim supports 28a are located at the support position. Next, as illustrated in FIG. 8, the lower rim holding mechanism 32d is driven to release the first lower rim 40d1 held by the lower rim holding mechanism 32d. Next, the conveyor lifting and lowering device 25 is driven to lift the center conveyor 22. In the process, the rim support surface 28b and the first lower rim 40d1 of the lower rim support 28a located at the support position come into contact with each other, and the first lower rim 40d1 is supported by the lower rim support 28a. Thereafter, the center conveyor 22 is continuously lifted, and stops at a position of (lower rim delivery height Hd+α). Here, the lower rim delivery height Hd is the height of the center conveyor 22 at which the level of the lower surface of the lower flange portion 45d in the first lower rim 40d1 supported by the lower rim support 28a of the center conveyor 22 is the same as the level of the flange support surface 63b of the lower rim support portion 62d. The position or the center conveyor 22 located at the height is the upper limit position of the center conveyor 22 described above.

In addition, α is approximately several mm to 2 cm. Next, the rim elevator 37 is lifted or lowered to lift or lower the first upper rim 40u1 held by the upper rim holding mechanism 32u. The rim elevator 37 stops at a position of (upper rim delivery height is Hu+α). Here, the upper rim delivery height Hu is the height of the rim elevator 37 at which the level of the lower surface of the upper flange portion 45u in the first upper rim 40u1 supported by the upper rim holding mechanism 32u is the same as the level of the flange support surface 63b of the upper rim support portion 62u. In addition, as described above, α is approximately several mm to 2 cm.

According to the above-described operation, the exchange preparation step is completed. In the exchange preparation step, the rim elevator 37 is lifted or lowered after the center conveyor 22 is lifted. However, the center conveyor 22 may be lifted after the rim elevator 37 is lifted or lowered. In addition, the rim elevator 37 may be lifted or lowered, and simultaneously, the center conveyor 22 may be lifted.

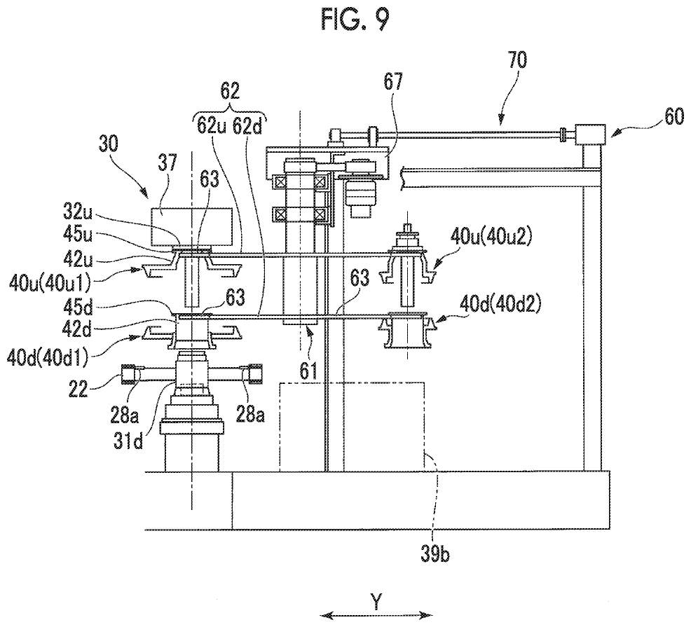

Next, a receiving step is performed. In the receiving step, as illustrated in FIG. 9, the stocker moving mechanism 70 is first driven so that the rim stocker 61 moves forward from the retreat position to the delivery position. Since the stocker 61 moves forward, the upper and lower rim support section 62 which does not support the upper rim 40u and the lower rim 40d reaches a position where the first upper rim 40u1 and the first lower rim 40d1 can be received. At this position, the cylinder portion 42u of the first upper rim 40u1 enters a portion between the two support arms 63 of the upper rim support portion 62u in the upper and lower rim support section 62, and the cylinder portion 42d of the first lower rim 40d1 enters a portion between the two support arms 63 of the lower rim support portion 62d in the upper and lower rim support section 62. However, the upper flange portion 45u of the first upper rim 40u1 and the flange support surface 63b of the upper rim support portion 62u are separated from each other in the vertical direction, and both of these are not in contact with each other. In addition, the lower flange portion 45d of the first lower rim 40d1 and the flange support surface 63b of the lower rim support portion 62d are separated from each other in the vertical direction, and both of these are not in contact with each other.

Next, the rim elevator 37 is lowered as much as α described above. As a result, the upper flange portion 45u of the first upper rim 40u1 comes into contact with the flange support surface 63b of the upper rim support portion 62u. Then, the upper rim holding mechanism 32u is driven so that the upper rim holding mechanism 32u releases the first upper rim 40u1. As a result, the first upper rim 40u1 is supported by the upper rim support portion 62u.

Next, the conveyor lifting and lowering device 25 is driven to lower the center conveyor 22. Since the center conveyor 22 is lowered, the lower flange portion 45d of the first lower rim 40d1 supported by the lower rim support 28a of the center conveyor 22 comes into contact with the flange support surface 63b of the lower rim support portion 62d. As a result, the first lower rim 40d1 is supported by the lower rim support portion 62d. Thereafter, the center conveyor 22 is continuously lowered, and stops at an intermediate standby position above the lower limit position.

According to the above-described operation, the receiving step is completed. In the receiving step, the center conveyor 22 is lowered after the rim elevator 37 is lowered. However, the rim elevator 37 may be lowered after the center conveyor 22 is lowered. In addition, the rim elevator 37 may be lowered, and simultaneously, the center conveyor 22 may be lowered.

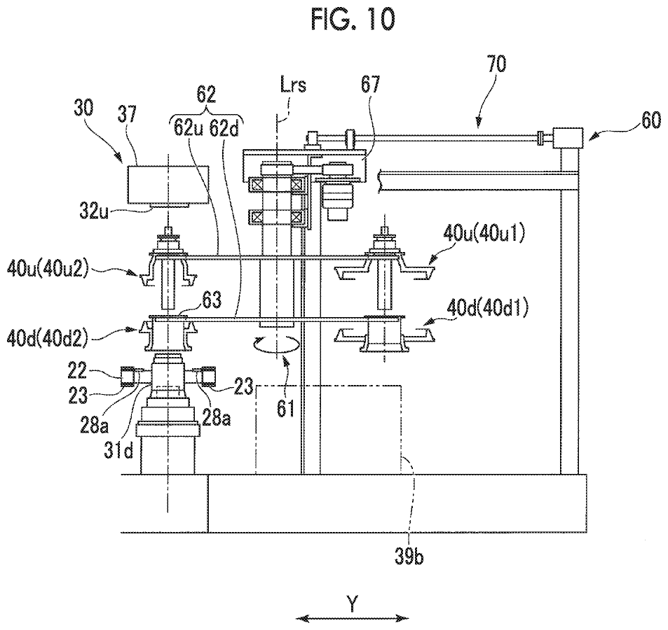

Next, a delivery step is performed. In the delivery step, as illustrated in FIG. 10, the rim elevator 37 is first lifted to the intermediate standby position, and stops at the intermediate standby position. Next, the belt opening-closing mechanism 24 is driven to change an interval in the passage width direction Y between the pair of belts 23 configuring the center conveyor 22. As a result, the interval between the pair of belts 23 is set so that all of the lower rim supports 28a can support the second lower rim 40d2. Next, the stocker rotating mechanism 67 is driven so that the plurality of upper and lower rim support sections 62 are rotated around the stocker rotational axis Lrs. Since the plurality of upper and lower rim support sections 62 are rotated, the upper and lower rim support section 62 which supports the second upper rim 40u2 and the second lower rim 40d2 reaches the delivery position.

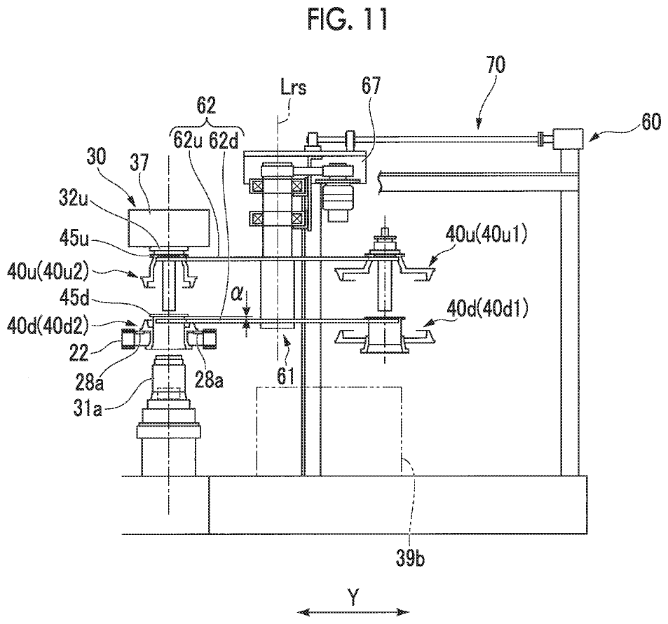

Next, as illustrated in FIG. 11, the rim elevator 37 is lowered from the intermediate standby position to the upper rim delivery height Hu, and stops at the upper rim delivery height Hu. Then, the upper rim holding mechanism 32u is driven to hold the second upper rim 40u2 supported by the upper rim support portion 62u. As described above, the upper rim delivery height Hu is the height of the rim elevator 37 at which the level of the lower surface of the upper flange portion 45u of the second upper rim 40u2 supported by the upper rim support portion 62u is the same as the level of the flange support surface 63b of the upper rim support portion 62u. In other words, the upper rim delivery height Hu is the height of the rim elevator 37 at which the second upper rim 40u2 supported by the upper rim support portion 62u can be held by the upper rim holding mechanism 32u. Next, the center conveyor 22 is lifted from an intermediate retreat position to the position of (lower rim delivery height is Hd+α), and stops at this position. In the process, the lower rim support 28a of the center conveyor 22 and the second lower rim 40d2 come into contact with each other, and the second lower rim 40d2 is supported by the lower rim support 28a. As described above, the lower rim delivery height Hd is the height of the center conveyor 22 at which the level of the lower surface of the lower flange portion 45d of the lower rim 40d2 supported by the lower rim support 28a of the center conveyor 22 is the same as the level of the flange support surface 63b of the lower rim support portion 62d.

According to the above-described operation, the delivery step is completed. In the delivery step, the center conveyor 22 is lifted after the rim elevator 37 is lowered. However, the rim elevator 37 may be lowered after the center conveyor 22 is lifted. In addition, the rim elevator 37 may be lowered, and simultaneously, the center conveyor 22 may be lifted.

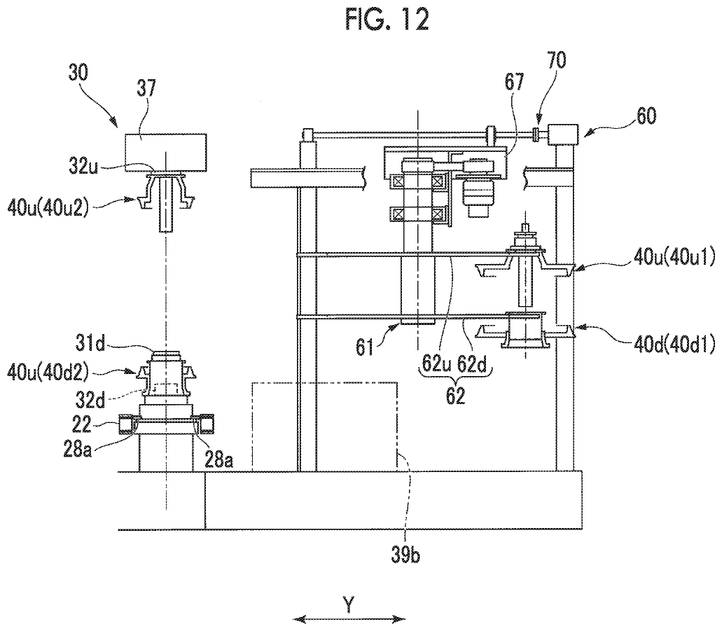

Finally, a tire test preparation step is performed. In the tire test preparation step, the stocker moving mechanism 70 is first driven so that the rim stocker 61 retreats to the retreat position as illustrated in FIG. 12. Next, the rim elevator 37 is lifted to a standby position. Next, the conveyor lifting and lowering device 25 is driven so that the center conveyor 22 is lowered to the lower limit position. In the lowering process of the center conveyor 22, the second lower rim 40d2 supported by the lower rim support 28a of the center conveyor 22 comes into contact with the lower spindle 31d. When the second lower rim 40d2 come, into contact with the lower spindle 31d, the lower rim holding mechanism 32d is driven to hold the second lower rim 40d2.

According to the above-described operation, the tire test preparation step completed. In the tire test preparation step, after the rim stocker 61 retreats to the retreat position, the rim elevator 37 is lifted to the standby position. Furthermore, thereafter, the center conveyor 22 is lowered to the lower position. However, the order for causing the rim stocker 61 to retreat, lifting the rim elevator 37, and lowering the center conveyor 22 is not limited to the above-described configuration, and other orders may be used. The rim stocker 61 may retreat, the rim elevator 37 may be lifted, and simultaneously, the center conveyor 22 may be lowered.

When the tire test preparation step is complete, the elevator 37 is located at the standby position. The second upper rim 40u2 is held by the upper rim holding mechanism 32u disposed in the rim elevator 37. In addition, the center conveyor 22 is located at the lower limit position. The second lower rim 40d2 is held by the lower rim holding mechanism 32d. The rim stocker 61 is located at the retreat position. The first upper rim 40u1 and the second lower rim 40d2 are supported by any one of the plurality of upper and lower rim support sections 62 of the rim stocker 61.

When the tire test preparation step is completed, the tire T corresponding to the second upper rim 40u2 and the second lower rim 40d2 which are held by the rim holding machine 30 is placed on the inlet conveyor 11 of the pre-treatment device. As described above, the pre-treatment device 10 performs the pre-treatment on the tire T, the inspection device 20 performs the test on the tire T, and the post-treatment device 50 performs the post-treatment on the tire T.

As described above, according to the present embodiment, both the upper rim support portion 62u and the lower rim support portion 62d of the rim stocker 61 have the open end 63a. Accordingly, when the rim stocker 61 is horizontally is moved, the cylinder portion 42 of each rim can enter the portion between the two support arms 63 without relatively moving the upper rim holding mechanism 32u or the lower rim holding mechanism 32d in the vertical direction with respect to the rim stocker 61. Therefore, owing to at least one of the following reasons 1), 2), and 3), a time required for exchanging the rim can be shortened.

1) A distance for relatively moving the upper rim 40u upward and downward with respect to the upper rim support portion 62u is shortened.

2) The number of steps of moving the upper rim 40u upward and downward decreases.

3) Restrictions are relaxed on timing for performing a step of moving the upper rim 40u upward and downward and timing for performing a step of horizontally moving the upper and lower rim support section 62.

Specifically, for example, with regard to the reason 3)described above, in the tire test preparation step according to the present embodiment, as described above, the rim elevator 37 can be lifted (the upper rim 40u can be lifted), and simultaneously the rim stocker 61 can retreat (the upper and lower rim support section 62 can be horizontally moved). On the other hand, according to the technique disclosed in PTL 1, unless the spindle portion of the upper rim is removed from the rim hole of the upper seat plate by lifting the upper rim 40u, the rim stocker cannot retreat. Therefore, although repeatedly described, according to the present embodiment, the time required for exchanging the rim can be shortened compared to the technique disclosed in PTL1.

In addition, the rim stocker 61 according to the present embodiment has the plurality of upper and lower rim support sections 62. Therefore, according to the present embodiment, out of the plurality of upper and lower rim support sections 62, the upper rim 40u and the lower rim 40d which are to be exchanged with one upper and lower rim support section 62 are supported. When the other remaining upper and lower rim support section 62 is vacant, the rim stocker 61 reciprocates once. In this manner, the upper rim 40u and the lower rim 40d can be exchanged between the rim holding machine 30 and the rim exchanger 60.

The stocker moving mechanism 70 according to the present embodiment is located above the plurality of upper and lower rim support sections 62, and hangs and holds the rim stocker 61. Therefore, according to the present embodiment, the space below the rim stocker 61 is not occupied by the stocker moving mechanism 70. Accordingly, the space below the rim stocker 61 can be effective used. Specifically, for example, as illustrated in FIG. 3, a dimension measuring instrument 39b serving as a tire measuring instrument can be located below the stocker moving mechanism 70 and the rim stocker 61.

According to the present embodiment, when the lower rim 40d is relatively moved with respect to the lower rim holding mechanism 32d, the lower rim 40d is supported by the lower rim support 28a. Moreover, according to the present embodiment, the lower rim support 28a is located at the position below the upper surface of the belt 23, which is the position different from that of the belt 23 in the horizontal direction. Therefore, according to the present embodiment, when the lower rim 40d is relatively moved with respect to the lower rim holding mechanism 32d, the lower rim 40d does not come into contact with the belt 23. Accordingly, it is possible to prevent the belt 23 from being damaged.

### Modification Example

The present invention is not limited to the above-described embodiments, and includes those in which various modifications are added to the above-described embodiments within the scope not departing from the gist of the present invention. That is, the specific shapes or configurations described in the respective embodiments are merely examples, and can be modified as appropriate.

According to the above-described embodiment, the center conveyor 22 is relatively moved with respect to the lower rim 40d by lowering the center conveyor 22. However, for example, the center conveyor 22 may be relatively moved with respect to the lower rim 40d by lifting the lower rim 40d.

According to the above-described embodiment, the first rim moving mechanism which relatively moves the upper rim holding mechanism 32u in the vertical direction with respect to the lower rim holding mechanism 32d is the rim elevator 37 which moves the upper rim holding mechanism 32u in the vertical direction. However, the first rim moving mechanism may be a mechanism which moves the lower rim holding mechanism 32d in the vertical direction. In addition, the second rim moving mechanism which relatively moves the rim serving as a holding target of one rim holding mechanism in the vertical direction with respect to one rim holding mechanism out of the upper rim holding mechanism 32u and the lower rim holding mechanism 32d is the conveyor lifting and lowering device 25 which relatively moves the lower rim 40d together with the center conveyor 22 in the vertical direction with respect to the lower rim holding mechanism 32d. However, the second rim moving mechanism may be a mechanism which relatively moves the upper rim 40u in vertical direction with respect to the upper rim holding mechanism 32u.

In addition, according to the above-described embodiment, while the tire T is first delivered to the lower rim 40d, the upper rim 40u is lowered. In this manner, the tire T is interposed between the upper rim 40u and the lower rim 40d. However, after the tire T is first delivered to the upper rim 40u, the lower rim 40d may be moved close to the tire T. In this manner, the tire T may be interposed between the upper rim 40u and the lower rim 40d.

The protrusion portion 45 of the rim 40 according to the above-described embodiment is a plate-shaped flange portion that protrudes outward in the radial direction from the cylinder portion 42 of the rim 40 with respect to the rim axis. However, as long as the protrusion portion 45 protrudes outward in the radial direction from the cylinder portion 42 of the rim 40 with respect to the rim axis, the protrusion portion 45 may not have a plate shape. That is, the protrusion portion 45 may not be a flange.

In addition, the above-described embodiment is applied to the tire test system. However, the rim exchanger according to the present invention may be applied to systems in addition to the tire test system.

### INDUSTRIAL APPLICABILITY

According to an aspect of the present invention, a rim van be exchanged in a short time.

### REFERENCE SIGNS LIST

10: pre-treatment device

11: inlet conveyor

12: centering mechanism

20: inspection device

21: frame

21a: base

21b: main frame

22: center conveyor

23: belt

24: belt opening-closing mechanism

25: conveyor lifting and lowering device

25a: guide means

26a: upstream-side pulley

26b: downstream-side pulley

27: conveyor frame

28: lower rim support mechanism

28a: lower rim support

28b: rim support surface

26c: support moving mechanism

30: rim holding machine (tire holding machine)

31d: lower spindle

32u: upper rim holding mechanism

32d: lower rim holding mechanism

37: rim elevator

37a: guide means

39: tire measuring instrument

39b: dimension measuring instrument

40: rim

40u: upper rim

40u1: first upper rim

40u2: second upper rim

40d: lower rim

40d1: first lower rim

40d2: second lower rim

41u: upper rim body

41d: lower rim body

42: cylinder portion

42u: upper rim cylinder portion

42d: lower rim cylinder portion

43u: upper rim holding target portion

43d: lower rim holding target portion

44u: upper bead fitting portion

44d: lower bead fitting portion

45: flange portion (protrusion portion)

45u: upper flange portion (protrusion portion)

45d: lower flange portion (protrusion portion)

46u: upper spindle portion

49: tire stripper

50: post-treatment device

51: outlet conveyor

60: rim exchanger

61: rim stocker

62: upper and lower rim support section

62u: upper rim support portion

62d: lower rim support portion

63: support arm

63a: open end

63b: flange support surface (protrusion portion

support surface)

64: arm connecting portion

65: connection portion

66: stocker rotary shaft portion

67: stocker rotating mechanism

68a: driven pulley

68b: driving pulley

68c: belt

68d: motor

68e: bearing

69: base

70: stocker moving mechanism

71: screw shaft

72: nut member

72a: bearing

72b: motor

75: exchanger frame

75a: column

75b: cross beam

T: tire

Tbu: upper bead portion

Tbd: lower bead portion

Twu: upper side wall

Twd: lower side wall

Lc: passage center line

Lr: rotational axis

Lru: upper rim axis

Lrd: lower rim axis

Lrs: stocker rotational axis

X: transport direction

(−)X: upstream-side

(+)X: downstream-side

Y: passage width direction

1. A rim exchanger for exchanging an upper rim and a lower rim each of which has a rim body to fit into a tire and a protrusion portion protruding from the rim body with a rim holding machine holding the upper rim and the lower rim, the rim exchanger comprising:
a rim stocker that supports the upper rim and the lower rim; and
a stocker moving mechanism that moves the rim stocker between a delivery position where the upper rim and the lower rim can be delivered to and from the rim holding machine and a retreat position away from the rim holding machine,
wherein the rim stocker includes an upper and lower rim support section having an upper rim support portion that supports the upper rim, a lower rim support portion that supports the lower rim, and a connection portion that connects the upper rim support portion and the lower rim support portion to each other, and
wherein both the upper rim support portion and the lower rim support portion have a pair of support arms separated from each other in a horizontal direction, a portion between a tip of one of the support arms and a tip of the other of the support arms forms an open end where the rim body enters a portion between the pair of support arms, and each upper surface of the pair of support arms forms a protrusion portion support surface which supports the protrusion portion from below.

2. The rim exchanger according to claim 1,
wherein the lower rim support portion is located relative to the upper rim support portion so that a center position of the upper rim when the upper rim support portion supports the upper rim and a center position of the lower rim when the lower rim support portion supports the lower rim coincide with each other, when viewed in a vertical direction.

3. The rim exchanger according to claim 1,
wherein the rim stocker includes a plurality of the upper and lower rim support sections, a stocker rotary shaft portion rotated around a stocker rotational axis extending in a vertical direction, and a stocker rotating mechanism that rotates the stocker rotary shaft portion, and
wherein the plurality of upper and lower rim support sections are fixed to the stocker rotary shaft portion so that the open end of each of the upper and lower rim support sections faces outward in a radial direction with respect to the stocker rotational axis.

4. The rim exchanger according to claim 1,
wherein the stocker moving mechanism hangs and holds the rim stocker.

5. A rim holding device comprising:
the rim exchanger according to claim 1; and
the rim holding machine,
wherein the rim holding machine includes
an upper rim holding mechanism that holds the upper rim to fit into an upper bead portion of the tire,
a lower rim holding mechanism that holds the lower rim to fit into a lower bead portion of the tire, below the upper rim,
a first rim moving mechanism that relatively moves the upper rim holding mechanism with respect to the lower rim holding mechanism in a vertical direction,
a second rim moving mechanism that relatively moves a rim serving as a holding target of one rim holding mechanism in a vertical direction with respect to the one rim holding mechanism between the upper rim holding mechanism and the lower rim holding mechanism, and
a conveyor that transports the tire on a transport passage extending in a horizontal direction.

6. The rim holding device according to claim 5,
wherein the rim holding machine includes a conveyor lifting and lowering device that lifts and lowers the conveyor,
wherein the conveyor includes a belt conveyor that has a belt on which the tire is placed, and a lower rim support that supports the lower rim by coming into contact with the lower rim,
wherein the lower rim support is located at a position different from that of the belt in the horizontal direction and below an upper surface of the belt, which is a position, and
wherein the conveyor lifting and lowering device configures the second rim moving mechanism.

7. A tire test system comprising:
the rim holding device according to claim 5; and
a measuring instrument that performs various measurements on the tire mounted on the upper rim and the lower rim which are held by the rim holding machine.
